(19) United States
(12) Patent Application Publication
(10) Pub. No.: US 2007/0138298 A1
(43) Pub. Date: Jun. 21, 2007

(54) Fabric interconnect system

(75) Inventor: George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/598,190

(22) PCT Filed: Feb. 24, 2005
(86) PCT No.: PCT/IB05/50686

§ 371 Date: Aug. 21, 2006

Related U.S. Application Data
(60) Provisional application No. 60/549,190, filed on Mar. 2, 2004.

(51) Int. Cl. G06K 19/06

(52) U.S. Cl. 235/492

(57) ABSTRACT

There is provided a fabric interconnect system (1) operatively integrated, at least in part, into a textile. The inter-connect system (1) includes a connector (10) with at least two perforated layers (20) with perforations (22) and one or more flexible layers (30) of material with protruding fibers (32) that are suitable to permeate and/or engage the at perforations (22) to accomplish a secure electrical and mechanical connection.

The present invention relates to connectors for wearable electronics. More particularly, the present invention relates to an interconnect system for achieving an effective mechanical and electrical connection between a “hard” device and a garment fabric.

With advances in technology, there are now various electronic items that require adherence to or integration with fabric and garments. In most textile electronic applications it is desirable to mechanically and electrically connect a “hard” electronic device to a fabric in a quick and secure manner. Conventional electric connectors are not well suited for this type of connection as connectors for coupling to wearable fabrics typically have different, more rigorous requirements.

That is, often these connectors are required to endure moisture, wide temperature variation, as well as other extreme environmental conditions common to outdoor activities such as skiing, hiking, jogging or biking. Such connectors can be, and frequently are, quickly and unexpectedly disconnected from various angles as the electrical wires attached to the connector are often inadvertently caught during the physical movement of the wearer. Since the fabric with the attached connector is often in motion, there is often constant strain on the electrical leads that tug at the connector attempting to break its electrical contact.

From a practical perspective, an appropriate fabric interconnect system should be non-irritating when worn. The interconnect system should also be aesthetically pleasing as it is often outwardly visible. Also, since an electrical device may not always be connected to the fabric, the interconnect system should be discrete and free of any exposed sharp protrusion. Still further, the interconnect system should be lightweight to allow its mass to be supported by any of a variety of fabrics, light/thin or heavy/thick. Further, the interconnect system should be suitably resilient to withstand numerous couplings, typical wear and tear, and cleaning via conventional methods. The interconnect system, while exposed to the above adverse conditions, should be suitable to maintain electrical continuity at all times.

Accordingly, there is a need for a fabric interconnect system that is capable of meeting all the stringent requirements discussed above and that can quickly and securely connect, directly or indirectly, an external electronic device to the fabric of a garment such that an exchange of electrical signals between the electronic device and the garment may be achieved.

It is an object of the present invention to provide a fabric interconnect system that enables a quick and secure electrical and mechanical connection of an electronic device to a fabric.

It is another object of the present invention to provide a fabric interconnect system that is, in part, integral with the fabric and, in part, external to the fabric.

It is another object of the present invention to provide a fabric interconnect system that has a connector with at least two layers of perforated material, and a fabric with protruding fibers suitable to engage the at least two layers of perforated material.

It is another object of the present invention to provide a fabric interconnect system that facilitates selectively connecting an electronic device to the fabric in a mechanical and electrical manner.

It is another object of the present invention to provide a fabric interconnect system that is sufficiently resilient to withstand numerous couplings.

It is another object of the present invention to provide a fabric interconnect system that can maintain electrical continuity under conditions of normal wear and tear associated with fabric incorporated into one or more portions of a wearable garment.

It is another object of the present invention to provide a fabric interconnect system that is aesthetically appealing, lightweight, shock resistant, and substantially discrete when not in use.

These and other objects and advantages of the present invention are achieved by a fabric interconnect system operatively integrated, at least in part, in a textile, and preferably a wearable garment. The interconnect system includes a connector with at least two layers of perforated material and one or more layers of flexible material with protruding fibers that are suitable to permeate and/or engage the at least two layers of perforated material.

The present invention is more fully understood by reference to the following detailed description of an illustrative embodiment in combination with the drawings identified below.

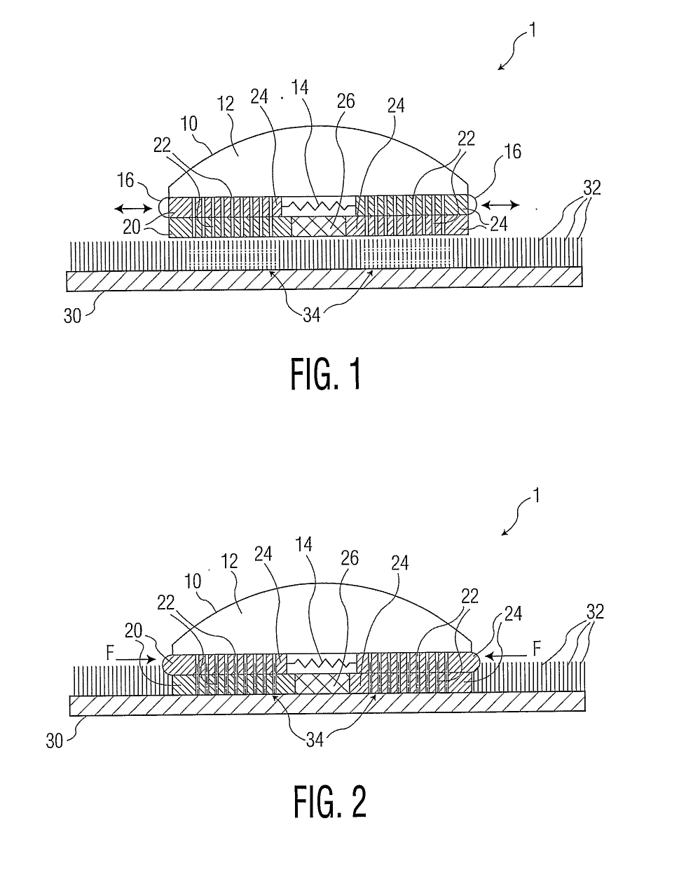

FIG. 1 is a schematic side section view of an air filter and/or ionizer in accordance with an illustrative embodiment of the present invention;

FIG. 2 is a schematic exploded perspective view of the air filter and/or ionizer of FIG. 1;

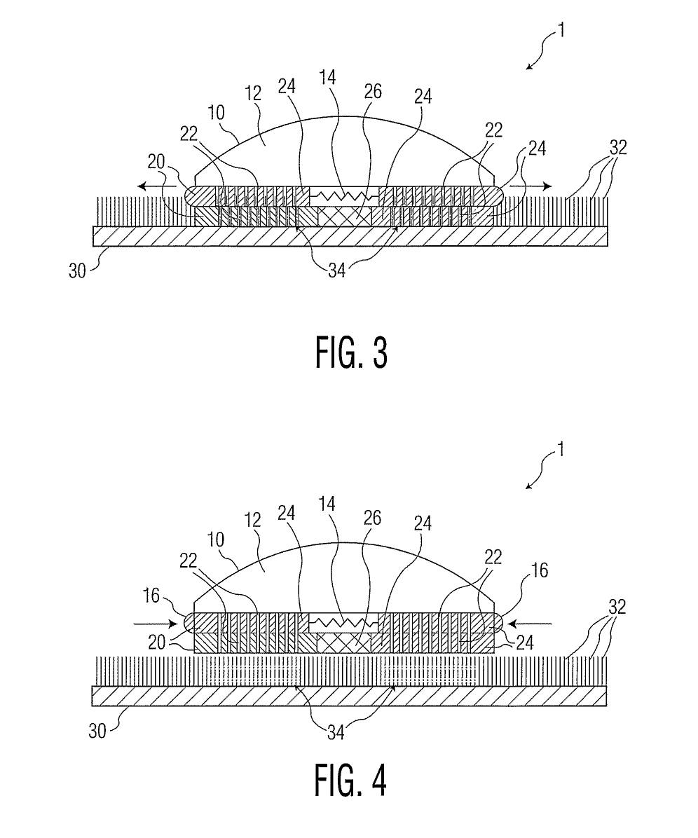

FIG. 3 is a schematic of a garment in accordance with an illustrative embodiment of the present invention, showing the air filter and/or ionizer of FIG. 1 in a first inoperative state; and

FIG. 4 is a schematic of a garment in accordance with an illustrative embodiment of the present invention, showing the air filter and/or ionizer of FIG. 1.

Referring to the drawings and in particular, FIG. 1, there is shown a fabric interconnect system in accordance with an illustrative embodiment of the present invention generally represented by reference numeral 1. Fabric interconnect system 1 can be operatively integrated, at least in part, into any of a variety of textile fabrics. Fabric interconnect system 1 includes at least a connector 10 having at least two layers of perforated material 20 and one or more layers of flexible material 30 having one or more protruding fibers 32 appropriate to permeate and/or engage perforated material 20.

As shown, connector 10, which can be integral to any of a variety of devices, or alternatively, separably coupled thereto as appropriate for a particular application, preferably has a body 12 for holding the at least two layers of perforated material 20. Body 12 can have any shape, size and/or configuration appropriate for accomplishing the stated objectives of the present invention. For example, body 12 can be part of a larger electronic device or system (not shown) suitable for wearable electronic applications.

In a preferred aspect of the present invention, the at least two layers of perforated material 20, which are preferably placed adjacent each other, are at least relatively rigid and have one or more perforations 22 of sufficient size to accommodate one or more protruding fibers 32. Perforations 22 and/or perforated material 20 can be shaped or configured into as appropriate to accomplish the stated objectives of the present invention. For example, perforations 22 can be specifically sized to accommodate or receive only certain fibers having a particular size, shape or configuration. This feature can facilitate in connecting connector 10 to one or more layers of flexible material 30 in a secure electrical and/or mechanical manner.

Preferably, each of the at least two layers of perforated material 20 have two or more conductive portions 24. These conductive portions are preferably insulated or separated from each other to facilitate an electrical connection via a DC power supply, for example. Conductive portions 24 may be inherently conductive via the properties of the perforated material itself. Alternatively, or in addition conductive portions 24 may be made conductive using a conductive coating, for example, such as a conductive ink. Conductive portions 24 may be directly or indirectly connected to a power source (not shown). Conductive portions 24 can have any shape, size and/or configuration suitable to accomplish the state objectives of the present invention.

In another aspect of the present invention, connector 10 can have one or more biasing elements 14 preferably operative to bias the two or more conductive portions 24 of the at least two layers of perforated material 20 relative to each other. Biasing elements 14 can take any of a variety of forms, such as, for example, a spring as shown if FIG. 1.

In still another aspect of the present invention, connector 10 can have one or more actuators 16 operatively connected to either conductive portions 24 or biasing elements 14. Preferably, one or more actuators 16 allow for the selective positioning of conductive portions 24 relative to each other. One or more actuators 16 can be any of a variety of structures (e.g., squeeze buttons, press buttons, levers, etc.). As shown, actuators 16 can be side buttons that are connected directly to conductive portions 24 so that when actuators 16 are acted on, conductive portions 24 are caused to move. Thus, in this aspect of the present invention, when at least two layers of perforated material 20 are adjacent each other, the conductive portions 24 of at least one perforated layer may be caused to move with respect to at least one other perforated layer such that the perforations 22 of each may be selectively aligned and/or misaligned.

In a further aspect of the present invention, the one or more jutting or protruding fibers 32 of the one or more flexible layers 30 are grouped into two or more predefined areas 34. These predefined areas 34 are preferably insulated from each other and conductive, preferably being in electrical communication with a power supply, such as, for example a direct current (DC) power source (not shown).

Preferably, conductive predefined areas 34 may be inherently conductive via the properties of at least some of the protruding fibers 32 therein. For example, protruding fibers 32 of conductive predefined areas 34 can be made of any suitable conductive material, including for example, a metalized foil, a conductive polymer, or a graphitized or metalized fiber or yarn. Alternatively or in addition predefined areas 34, and/or protruding fibers 32 thereof, may be made conductive using a conductive coating, such as, for example, a conductive ink. The predefined areas 34 can be made easily visible, so identification and/or connection thereto can be easily made on a visual basis.

Preferably, protruding fibers 32 can have any of a variety of shapes, sizes and/or configurations suitable to accomplish the stated objects of the present invention. For example, each protruding fiber 32 can have a high tensile strength and a weight and consistency of a material that provides a high degree of flexibility during manufacture and wear, as well as permeate and/or engage the at least two layers of perforated material 20. In addition, conductive protruding fibers 32 of the predefined conductive areas 32 can be electrically directly or indirectly connected to a power source. Protruding fibers 32 may have different shapes, sizes or configurations to accommodate different applications including, for example, the stated objectives of the present invention.

Having described some of the preferred aspects of the present invention, it is appreciated that details may be modified in a variety of ways and that alternative embodiments are also within the scope of the present invention.

Referring now to FIGS. 2 through 4, in application, connector 10 can be securely connected to the one or more layers of flexible material 30 by activating one or more actuators 16 to overcome biasing elements 14 and bias one or more conductive portions 24 of at least one layer of perforated material 20 relative to each other. For example, as shown in FIG. 2, biasing elements 14 can bias conductive portions 24 of at least one perforated layer 20 to at least a first position relative to each other. Preferably, in the at least one first position, one or more perforations 22 of each perforated layer 20 are misaligned. Further, as shown in FIG. 3, by applying a force F to actuators 16, conductive portions 24 can be biased to at least a second position relative to each other. Preferably, in the at least one second position, one or more perforations 22 of each perforated layer 20 are aligned.

Thus, when one or more perforations 22 of at least two adjacent perforated layers 20 are aligned, connector 10 can be brought into contact with one or more layers of flexible material 30 and protruding fibers 32 can enter or engage perforations 22 as shown in FIG. 2. Once protruding fibers 32 engage perforations 22, actuators 16 may be deactivated so that perforations 22 become misaligned via one or more biasing elements 14 as shown in FIG. 3. Protruding fibers 32 and, more preferably, protruding fibers 32 of at least one conductive predefined area 32 are preferably securely mechanically and electrically connected to one or more conductive portions 24 of at least one of the perforated layers 20 when perforations 22 of layers of perforated material are misaligned. It is noted that the connector 10 can be separated from the one or more layers of flexible material 30 in a similar manner to the foregoing.

The present invention having been thus described with particular reference to the illustrated embodiments thereof, it will be obvious that various changes and modifications may be made therein without departing from the spirit of the present invention as defmed herein.

What is claimed is:

1. A fabric interconnect system (1) comprising:
a connector (10) with at least two perforated layers (20) of material with one or more perforations (22); and
one or more flexible layers (30) of material with one or more jutting fibers (32),
wherein said jutting fibers (32) are appropriate to engage said at least two perforated layers (20).

2. The fabric interconnect system (1) of claim 1, wherein at least one of said at least two perforated layers (20) has at least two conductive portions (24).

3. The fabric interconnect system (1) of claim 2, wherein said connector (10) has one or more biasing elements (14) for biasing said at least two conductive portions (24) relative to each other.

4. The fabric interconnect system (1) of claim 3, wherein said connector (10) has one or more actuators (16) for selectively positioning said at least two conductive portions (24) relative to each other.

5. The fabric interconnect system (1) of claim 4, wherein said one or more actuators (16) and said one or more biasing elements (14) are operatively connected via said at least two conductive portions (24).

6. The fabric interconnect system (1) of claim 5, wherein one or more perforations (22) of said at least two perforated layers (20) are misaligned with respect to each other when said one or more biasing elements (14) are in a relaxed state.

7. The fabric interconnect system (1) of claim 6, wherein said one or more perforations (22) of said at least two perforated layers (20) are selectively aligned with respect to each other via said one or more actuators (16).

8. The fabric interconnect system (1) of claim 7, wherein said connector (10) can be securely connected to said one or more flexible layers (30) of material by activating said one or more actuators (16) to align said one or more perforations (22) of said at least two perforated layers (20), bringing said connector (10) into contact with said one or more flexible layers (30) of material such that said jutting fibers (32) engage said aligned perforations, and deactivating said one or more actuators (l6) such that said one or more perforations (22) are misaligned via said biasing element.

9. A fabric connector (10) comprising:
two or more perforated layers (20) of material at least one of which having two or more conductive portions (24);
one or more biasing elements (14) operatively connected to said two or more conductive portions (24); and
one or more actuators (16) operatively connected to said one or more biasing elements (14) and/or said two or more conductive portions (24).

10. The fabric connector (10) of claim 9, wherein said one or more biasing elements (14) bias said two or more conductive portions (24) to a first position relative to each other.

11. The fabric connector (10) of claim 10, wherein a force applied to one or more actuators (16) selectively biases said two or more conductive portions (24) to a second position relative to each other.

12. The fabric connector (10) of claim 11, wherein said one or more perforations (22) of each said at least two or more perforated layers (20) of material are misaligned in said first position.

13. The fabric connector (10) of claim 12, wherein said one or more perforations (22) of each said at least two perforated layers (20) are aligned in said second position.

14. The fabric connector (10) of claim 13, wherein said at least two or more perforated layers (20) of material each have one or more perforations (22) that are appropriate to accommodate one or more protruding fibers (32) of a second material.

15. The fabric connector (10) of claim 14, wherein said connector (10) can be securely connected to said second material.

16. The fabric connector (10) of claim 15, wherein said protruding fibers (32) are grouped into two or more predefined areas (34).

17. The fabric connector (10) of claim 16, wherein said two or more predefined areas (34) are insulated from each other.

18. The fabric connector (10) of claim 17, wherein said protruding fibers (32) of said predefined areas (34) are conductive and in electrical communication with a power supply.

19. The fabric connector (10) of claim 18, wherein said power supply is a direct current (DC) power source.

20. The fabric connector (10) of claim 18, wherein said protruding fibers (32) can engage said one or more perforations (22) when said one or more perforations (22) of each said at least two perforated layers (20) are aligned, and wherein said protruding fibers (32) of said predefined conductive areas and said one or more perforations (22) of said two or more conductive portions (24) can be mechanically and electrically connected when said one or more perforations (22) of each said at least two perforated layers (20) are misaligned.
